(19) United States
(12) Patent Application Publication
(10) Pub. No.: US 2026/0243511 A1
(43) Pub. Date: Aug. 20, 2026

(54) METHOD FOR MANAGING A DEHYDRATION SYSTEM AND CORRESPONDING DEHYDRATION SYSTEM

(71) Applicant: LGD, Cergy (FR)

(72) Inventor: Jean-Gabriel DIJOUD, COLOMBES (FR)

(21) Appl. No.: 18/993,442

(22) PCT Filed: Jul. 12, 2023
(86) PCT No.: PCT/FR2023/051081

§ 371 Date: Jan. 10, 2025

(30) Foreign Application Priority Data
Jul. 13, 2022 (FR) 2207228

(51) Int. Cl. F26B 5/04; A23B 2/90; B01D 53/04; B01D 53/26; F26B 21/33; F26B 23/00

(52) U.S. Cl. CPC F26B 5/044; A23B 2/90; B01D 53/0438; B01D 53/261; F26B 21/331; F26B 23/005; B01D 2253/108; B01D 2257/80; B01D 2259/40088

(57) ABSTRACT

A method for managing a dehydration system suitable for dehydrating a product, comprises a drying device (5) containing an adsorbent material. The method includes phases of water adsorption (S2) by the adsorbent material in order to reduce the partial vapor pressure in a carrier fluid circulating in the system, and regeneration phases (S3) during which the adsorbent material recovers its adsorption properties. The adsorbent material is such that the water adsorption is exothermic. The method comprises recovering thermal energy (S5) from the drying device (5) during the water adsorption phases (S2), and using (S6) the recovered thermal energy for heating the product (S11); and/or + heating the adsorbent material (S32) in the regeneration phase. A dehydration system for carry out this method is also disclosed.

### CROSS-REFERENCE TO RELATED APPLICATIONS

This application is the US national stage of PCT/FR2023/051081, filed Jul. 12, 2023 and designating the United States, which claims the priority of FR2207228, filed Jul. 13, 2022. The entire contents of each foregoing application are incorporated herein by reference.

### BACKGROUND OF THE INVENTION

### Field of the Invention

The present invention relates to the field of dehydration and in particular that of dehydration facilities.

### Description of the Related Art

In general, dehydration corresponds to removing the water present in a product. This operation may have various objectives, for example enabling a long conservation of a product, or concentrating some elements thereof.

In particular, dehydration includes drying or desiccation processes under vacuum.

In particular, these methods include freeze-drying methods. Freeze-drying consists in desiccating a product frozen beforehand, by sublimation. Thus, freeze-drying is carried out by maintaining the product at a low temperature under vacuum. In the freeze-drying methods, the water extracted from the products is generally condensed by a cold plate system and then discharged from the freeze-drying facility.

Other processes of dehydration under vacuum are known.

Dehydrating under vacuum has several main advantages. Lowering the boiling point and therefore working at a lower temperature allows preserving the qualities of the dehydrated product. Dehydrating in the absence of oxygen or in the presence of little oxygen avoids the oxidation of some molecules.

However, the low pressures imply very large volumes of water vapor, which should therefore be “trapped”. There are different ways for trapping water: by physisorption, chemisorption, condensation.

Hence, in general, dehydration processes under vacuum comprise the use of a water trap containing an adsorbent material. A facility for implementing such methods generally comprises an enclosure that receives vessels of products to be dehydrated and assemblies containing the adsorbent material. Setting the enclosure under vacuum causes an evaporation of the water initially contained in the products and the water vapor thus produced is adsorbed by the adsorbent material.

The main applications of the dehydration technologies targeted in the present invention concern in particular the dehydration of food products, cosmetic products, and pharmaceutical products, bio-sourced products (for example, wood), or products included in the composition of such food, cosmetic or pharmaceutical products, etc.

Various dehydration devices have been known in the prior art since a very long time.

For example, document U.S. Pat. No. 2,374,232 discloses a vacuum dehydration device (in this case freeze-drying), using a desiccator material such as a silica gel. The product to be dehydrated is placed in a container which is in communication with a chamber which contains the desiccator material, which enables the free gas exchanges and a pressure balance between the container where the product is placed and the enclosure which contains the desiccator material.

Document FR2805759 relates to a method for dehydration in a similar system comprising at least one solid/gas reversible adsorption reactor of the common type which contains, in an enclosure, an adsorbent such as zeolite, a vat containing a product to be adsorbed (for example, placed on trays); and a fluid connection provided with a valve to allow setting the enclosure and the vat in communication and a pressure balance between the enclosure and the vat.

In particular, this document reminds that a method for implementing such a device conventionally comprises the following three successive phases:
an adsorption phase, during which the enclosure containing the adsorbent is set in communication with a vat containing the product to be dehydrated;
a regeneration phase, during which said enclosure containing the adsorbent is set in communication with a condensation system, said enclosure is isolated with respect to said vat, and said adsorbent is reheated; and
a cooling phase, during which said enclosure is isolated and said adsorbent is cooled.

In particular, the device and the method disclosed in this document relate to the conditions applied to the adsorbent, which could nevertheless be optimized further.

Document FR1009340 discloses a method for drying at low temperature, in two steps. Each drying step takes place in a different dryer, the first one operating at 25° C. and the second one at 13° C. The drying air is sucked in and first passes through a container containing a dehydrating agent. Afterwards, it is introduced into the second dryer (at 13° C.) from which it comes out wetter. In order to keep its evaporative power, the air is reheated afterwards to 25° C. and introduced into the first dryer. The air extracted from the dryers is sent into a container containing a desiccant. Another container contains a desiccant being regenerated by circulation of air in a closed circuit, heated by an external heat input. This circuit assists in heating the air between the second dryer and the first dryer.

Thus, facilities known so far are not optimized in an overall approach with regards to the dehydration process, in order to preserve the properties of the product while enabling an efficient implementation of the device.

In particular, the problem of the energy required to complete the entire dehydration process is important. Thus, in addition to providing an efficient dehydration device for preserving the properties of the dehydrated product, for example its gustatory qualities, it should be provided a device that has a competitive energy consumption compared to existing dehydration solutions.

The present invention aims to provide an optimized dehydration device.

### SUMMARY OF THE INVENTION

Thus, the invention relates to a method for managing a dehydration system adapted to dehydrate a product, the dehydration system comprising a drying device containing an adsorbent material, the method comprising:
water adsorption phases, by the adsorbent material in order to reduce the partial pressure of water vapor in a carrier fluid circulating in a dehydration system during the dehydration of the product, and
regeneration phases, under vacuum, at a pressure lower by at least 500 millibars than the atmospheric pressure, during which the adsorbent material recovers adsorption properties;

the adsorbent material being such that the water adsorption is exothermic,

the method comprises steps of:
recovering thermal energy at the drying device during the water adsorption phases, and
using the recovered thermal energy for:
heating the product during dehydration thereof; and
heating the adsorbent material in regeneration phase,

The method further comprises, between the regeneration phase and the adsorption phase, a phase of cooling the adsorbent material, and the step of recovering thermal energy comprises recovering thermal energy at the drying device during the phase of cooling the adsorbent material.

Thus, a method is proposed allowing considerably limiting the energy inputs necessary to conduct the dehydration of products and more generally for the operation of the dehydration system, which comprises the dehydration of the product itself and phases of regenerating the adsorbent material used in the system. In particular, the used adsorbent material may consist of or comprise a zeolite. By regeneration, it should be understood the reestablishment of the activity, i.e. the capacity to adsorb water, of the adsorbent material. For a zeolite, this consists in extracting water by setting it under favorable temperature and pressure conditions. A regeneration under vacuum allows for a more energy-efficient regeneration (insofar as part of the energy used for the regeneration could be recovered). In the present document, a regeneration under vacuum refers to a regeneration carried out under a pressure of at least 500 millibars under the atmospheric pressure (i.e. less than about 500 millibars in absolute pressure).

The energy efficiency of the method can be improved further according to the following modalities.

The step of recovering thermal energy may comprise recovering latent heat of condensation of the water vapor present in a gas flow expelled from the adsorbent material during the regeneration phase.

The step of recovering thermal energy may comprise recovering thermal energy at a mechanical device of the dehydration system, for example a pump, and the recovered thermal energy may be used for:
heating the product during dehydration; and/or
heating the adsorbent material in regeneration phase; and
maintaining the temperature of a heat-transfer fluid.

The dehydration system may comprise a second drying device, wherein the recovered thermal energy is used at least partially for heating the second drying device in regeneration phase.

The method proposed in the invention proves to be particularly relevant and effective in such a configuration. Thus, all or part of the recovered thermal energy of a drying device whose drying material is in the adsorption phase can be directly used for the regeneration of the drying material of a drying device in regeneration phase. Thus, the method is applicable to a dehydration system comprising several drying devices in particular two, three, four, five, drying devices or more.

The method may comprise the steps of:
placing the product in a dehydration enclosure;
establishing in the dehydration enclosure a pressure at least 500 millibars lower than the atmospheric pressure;
establishing a flow of carrier fluid between the inlet of the dehydration enclosure and an outlet of the dehydration enclosure; and
adsorbing water contained in the carrier fluid coming out of the dehydration enclosure by the adsorbent material contained in the drying device.

The pressure of the carrier fluid can be raised between the outlet of the dehydration enclosure and the drying device, for example by 300 millibars or more.

Indeed, while a low pressure is favorable to drying of the products, it is unfavorable to water adsorption by the adsorbent material.

To overcome this phenomenon and maximize the energy released because of the exothermic nature of the adsorption, it is proposed to use a system for compressing the carrier fluid between the dehydration enclosure and the drying device, in order to set the adsorbent under the most favorable conditions for adsorption.

Nevertheless, a consequence of maximizing the energy released during the adsorption, because of the adsorption of a large amount of water, is that this large amount of water will have to be eliminated by desorption during regeneration.

This is why a regeneration under vacuum is carried out, in order to minimize the energy necessary for regeneration.

The product may be brought and maintained at a temperature comprised between 20° C. and 70° C., preferably between 30° C. and 40° C., during dehydration thereof.

Thus, it is proposed to operate the dehydration system under optimum conditions, in particular from an energy perspective, in the different phases of the method. Thus, the dehydration is carried out under a low pressure, much lower than the atmospheric pressure, for example lower by more than 500 millibars than the atmospheric pressure (we talk about dehydration “under vacuum”). The relative humidity of the carrier fluid at the inlet of the dehydration enclosure is lower than 70% and will generally be much lower. The adsorption of water by the adsorbent material is carried out at a pressure higher than the pressure at which the product is dehydrated. The regeneration of the adsorbent material, typically zeolite, is carried out under vacuum.

It should be noted that, unless indicated otherwise, the expressions “about” and “in the range of” refer to the indicated value more or less 20%.

In some embodiments of the method, heating the adsorbent material in regeneration phase and heating the product during dehydration requiring a total amount of thermal energy, recovering thermal energy in the system covers at least 20%, preferably at least 50%, and more preferably at least 70% of said total amount of thermal energy. As this will be shown hereinafter, in a method in accordance with some embodiments of the present invention, it is possible to limit the thermal energy supplies necessary for the operation of the dehydration system to a very low level, and theoretically it is even possible to cancel them.

The invention also relates to a dehydration system comprising a dehydration enclosure in which a product to be dehydrated is placed, and at least one dehydration device comprising a drying device comprising an adsorbent material adapted to adsorb water contained in a carrier fluid that passes through the drying device, the adsorbent material being such that water adsorption is exothermic,
the dehydration device comprising a flow management module adapted to generate and control a flow of carrier fluid in the dehydration device and in the dehydration enclosure,
the dehydration system comprising:
   a thermal energy recovery device at the drying device and
   a device for distributing the thermal energy to a means for heating the product in the dehydration enclosure, and/or
   a means for storing the thermal energy for use thereof to heat the adsorbent material of the drying device when the latter is in regeneration phase,

The system comprises a vacuum source configured to set the adsorbent material at a pressure lower by at least 500 millibars than the atmospheric pressure during regeneration thereof, which is then referred to as “regeneration under vacuum”. Thus, all of the thermal energy recovery and distribution functions could be viewed as a recovery module, which can ensure the distribution or storage of the recovered thermal energy.

The device may comprise a second drying device, and the system may then further comprise a means for distributing the recovered thermal energy adapted to distribute to the second drying device all or part of the recovered thermal energy in order to heat the drying material of the second drying device when it is in regeneration phase.

The thermal energy recovery device may comprise a gas/liquid exchanger.

Thus, the energy is recovered in a heat-transfer fluid, for example oil. This allows storage thereof or, where necessary, transfer thereof, directly or via a liquid/liquid exchanger, towards a thermal circuit, comprising a heat-transfer fluid, and which allows, for example, heating the product that is being dehydrated.

The thermal energy recovery device may comprise a heat pump. The heat pump turns out to be relevant, in particular more relevant than a gas/liquid type heat exchanger, for example, when the temperatures of the gases from which thermal energy is to be extracted are relatively low, for example below 120° C.

The system may further comprise a means for recovering thermal energy emitted by mechanical devices of the system.

The energy thus recovered, for example by means of heat pumps, can be used in particular in a tracing system (i.e. an elongated heating system) along the lines of the system, complementarily with the heat insulation of the lines.

The dehydration enclosure of the system may comprise a set of racks for receiving vessels adapted to contain a product to be dehydrated and the means for heating the product may comprise a set of conduits containing a heat-transfer fluid totally or partially heated via one or more exchanger(s) connected to the thermal energy recovery device. This configuration optimizes the ratio between the evaporation surface exposed by the product and the volume of the enclosure, as well as the heating efficiency of the product.

Other particularities and advantages of the invention will appear better in the description hereinafter.

### BRIEF DESCRIPTION OF THE DRAWINGS

In the appended drawings, given as non-limiting examples:

FIG. 1 shows, according to a block diagram, a dehydration system in accordance with an embodiment of the invention;

FIG. 2 shows, according to a block diagram, an example of a method for managing a dehydration system in accordance with the invention, which could be applied in particular to the dehydration system of FIG. 1;

FIG. 3 shows on a block diagram the sorption curves as a function of pressure for an adsorbent material at two temperature levels;

FIG. 4 shows sorption results of an adsorbent obtained at a given temperature;

FIG. 5 shows sorption isotherms obtained at different temperatures for the adsorbent of FIG. 4.

### DETAILED DESCRIPTION

FIG. 1 shows, according to a block diagram, a dehydration system according to an embodiment of the present invention. The dehydration system comprises a dehydration device 1 and a dehydration enclosure 2 to which the dehydration device 1 is connected.

In order to dehydrate a product contained in the dehydration enclosure 2, a flow of a carrier fluid, for example air or advantageously nitrogen, at low pressure and having a low partial pressure of water vapor, is generated in the dehydration enclosure 2 by a flow management module 3 of the dehydration device 1.

The use of air at low pressure as a carrier fluid avoids oxidation of the product that is dehydrated. In this regard, the use of nitrogen as a carrier fluid is even more advantageous.

The dehydration enclosure 2 is adapted to operate at the targeted pressure during the dehydration of the products.

For example, it may have a generally tubular shape which is thus particularly well-suited to systems operating at a high vacuum level.

Throughout the present document, by “vacuum”, it should be understood a pressure lower by at least 500 millibars than the atmospheric pressure, and preferably lower by 700 millibars than the atmospheric pressure.

This dehydration enclosure 2 may have large dimensions to enable the dehydration of products on an industrial scale. For example, a tubular enclosure with an internal diameter of about 2.5 m and an internal length of 5 m may be used. These dimensions are given merely as example. In particular, systems whose dehydration enclosure 2 has a much larger volume may be considered.

The dehydration enclosure 2 comprises a suction tubing allowing discharging the air-laden carrier fluid (typically air and water vapor). The suction tubing is connected to the inlet of the dehydration device.

The enclosure is provided with a door allowing loading and unloading the products to be dehydrated.

Advantageously, the products may be loaded on trays or vessels, suited for food contact where appropriate. The treated products may be in solid or liquid (including pasty) form. The configuration of the dehydration enclosure 2 tends to maximize the exchange surface of the products with the carrier fluid, for example with air.

In order to promote dehydration thereof, in a dry carrier fluid, the products to be dehydrated may be heated (nevertheless, under vacuum, the dehydration is carried out at low temperature, for example between 30° C. and 70° C., which allows not altering some qualities of the treated products).

In particular, heating the products in the enclosure may be carried out using a hot heat-transfer fluid circulating in lines 21 integrated into shelves for receiving the trays or vessels of products formed in the enclosure 2.

The temperature of the heat-transfer fluid can be controlled by a thermoregulating device 4.

In particular, according to a preferred aspect of the present invention, the heat-transfer fluid could be heated thanks to the thermal energy recovered elsewhere in the dehydration system. In various embodiments of the present invention, this thermal energy recovery could be carried out at various locations, on various heat sources. Thermal energy originating from the exothermic adsorption of water by a drying device 5 detailed hereinafter could primarily be used to supply the energy necessary to heat the product to be dehydrated to the desired temperature.

After having circulated in the dehydration enclosure 2, around and/or in contact with the product to be dehydrated, the fluid comes out containing water, i.e. more water than at entry thereof. The carrier fluid then enters the dehydration device 1.

In particular, the flow management module 3 is intended to ensure the circulation of the carrier fluid in the dehydration system 1 and in the dehydration enclosure 2, and to control the relative humidity level in the dehydration enclosure 2. It could allow controlling the temperature of the carrier fluid introduced into the dehydration enclosure 2. Thus, the flow management module 3 enables a fine control of the dehydration conditions of the product. Thus, the flow management module 3 is advantageously configured to control a dehydration under vacuum, a depression being applied at the outlet of the dehydration device. The dehydration under vacuum allows carrying it out at low temperature, which preserves some qualities of the product that is dehydrated.

The flow management module 3 also allows controlling the flow rates and the pressure in the drying device (described hereinafter).

The flow management module 3 may comprise a piece of mechanical equipment, of the volumetric pump type, for example a rotor pump (roots pump), or any other equipment adapted to operate under high vacuum and to manage the flow rate of the carrier fluid at the outlet of the dehydration enclosure and consequently at the inlet of the drying device.

This equipment also forms a device for compressing the carrier fluid. The compression device allows raising the pressure of the carrier fluid between the inlet interface of the dehydration device and the drying device.

Throughout the present document, the upstream concept and the downstream concept should be understood according to the direction of flow of the carrier fluid.

Optionally, a buffer balloon 6 may be arranged between the mechanical equipment of the circulation module and the drying device 5.

The buffer balloon 6 allows for a better control and smoothing over time of the operating conditions of the drying device 5 (pressure and temperature).

In the embodiment shown in FIG. 1, the system comprises three drying devices 5, 5′, 5″.

Indeed, in the case where the carrier fluid is not totally recycled, or, in general, if it is necessary to perform a supply of carrier fluid in the dehydration system, the introduced carrier fluid could be air or another gas dried in a second drying device 5′ of the dehydration device.

Furthermore, a third drying device 5″, previously used for the dehydration of a product, may be provided for, and for example be regenerated. Thus, it will be available for use to adsorb water as soon as the drying device 5 or the second drying device 5′ would have to be regenerated. Thus, a production with no dead time related to the regenerations of the drying devices could be achieved.

The flow management device also allows maintaining the desired vacuum level by a vacuum supply made with a vacuum source 7, for example a vacuum pump or a vacuum unit (via a vacuum network).

In all embodiments, the circulation module may comprise a device for determining the relative humidity of the carrier fluid entering the dehydration device 1, for example a humidity sensor, and using this information for controlling the flow rates in the dehydration system.

As mentioned hereinabove, the dehydration device comprises a drying device 5 intended to collect the water present in the carrier fluid originating from the dehydration enclosure 2.

The drying device 5 allows lowering the amount of water present in the carrier fluid which is present around the drying device or passes therethrough. The drying device 5 comprises a material suitable for adsorbing a large amount of water, referred to as adsorbent material, under suitable temperature and pressure conditions. Thus, this type of drying device 5 is commonly referred to as “water trap”.

Zeolites are known for their high capacity to adsorb water, without taking in volume, and could therefore be used as an adsorbent material of a water trap.

For example, the adsorbent material may be installed in a basket or a rack arranged in the drying device, so as to be brought into contact, or to be passed through, where appropriate, by the vapor-laden carrier fluid that penetrates the water trap.

The adsorption reaction of the adsorbent material used in the context of the present invention being exothermic (as is the case in particular with zeolites), the thermal energy produced by the reaction could be recovered and exploited.

This heat recovery, during the adsorption phase, may be performed at the drying device 5, via a first heat recovery device RC1. The first heat recovery device RC1 may be a gas/gas exchanger or a gas/liquid exchanger. In particular, a gas/oil exchanger has been developed to form the first heat recovery device RC1.

The thermal energy thus recovered can be used to heat the product being dehydrated, and/or to assist in the regeneration of the adsorbent material.

It is further possible to carry out the regeneration of the adsorbent material immediately after the adsorption phase, in order to profit from the temperature acquired by the adsorbent material during adsorption and limit the supply of thermal energy necessary for the regeneration.

As regards heating of the product being dehydrated, if the first heat recovery device RC1 is a gas/liquid (for example gas/oil) exchanger, the liquid heated by the heat produced during the adsorption of water by the adsorbent material could be directed towards a liquid/liquid exchanger so that the recovered thermal energy is transferred to the heat-transfer fluid circulating in the lines allowing heating the product to be dehydrated.

As regards the use of the recovered thermal energy in order to regenerate the adsorbent material, this use may be carried out, according to the considered system and its current use, with no delay or in a deferred manner. In a system comprising only one drying device, or in a device comprising several drying devices but no drying device to be regenerated at the time of water adsorption by another drying device, the recovered thermal energy could be stored, for example by hot fluid storage (for example in a heat-insulated tank). In a device comprising several drying devices, the thermal energy recovered at a first drying device whose adsorbent material is in water adsorption phase could advantageously be used immediately to heat the adsorbent material of a second drying device to be regenerated.

Indeed, once the adsorbent material has adsorbed a large amount of water, it should be regenerated by desorbing the water it contains, so that it recovers its adsorption capacity.

For this purpose, the dehydration device comprises a regeneration module 8.

The regeneration module allows setting the adsorbent material of the water trap under temperature and pressure conditions suitable for regeneration thereof.

As regards the temperature, it is necessary to heat the adsorbent material for regeneration thereof, all or part of this heating being carried out thanks to the thermal energy recovered elsewhere in the system. As regards the pressure, the regeneration module may be configured in particular to carry out the regeneration under vacuum.

The regeneration module 8 is selected and configured according to the general operating mode of the dehydration device. Advantageously, the latter can operate in vacuum-assisted adsorption, in particular in vacuum swing adsorption (or VSA according to the English acronym standing for “Vacuum Swing Adsorption”), in which a low pressure is imposed during the regeneration and a relatively higher pressure is imposed during the adsorption.

Thermal energy that is generally lost, released in the atmosphere, in the known systems, could also be recovered during the regeneration phases. This primarily consists in recovering latent heat of condensation of the gas flow (typically an air flow) expelled from the zeolite during the regeneration phase. This hot gas flow has a high relative humidity level, and therefore a high enthalpy.

For example, the energy recovery is done by means of a second heat recovery device RC2, which may comprise an exchanger also allowing recovering the condensed water. The condensed water itself is hot, and could be used directly as a heat-transfer fluid or to heat a heat-transfer fluid of the system.

More particularly, in the second heat recovery device RC2, the latent heat of condensation could be recovered using a tubular exchanger. The sensible heat of the gas flow during regeneration could be recovered using a (gas/gas or gas/liquid) exchanger or a heat pump. The use of an exchanger is preferred above a given temperature, for example in the range of 120° C. whereas the use of a heat pump is preferred below this temperature (for example between 70° C. and 120° C.).

Thus, an energy recovery could be carried out at the drying device not only during the adsorption phase, but also, where appropriate, during the regeneration phase to recover part of the energy related to the initial heating of the zeolite—or more generally of the adsorbent material, and/or part of the energy inputs during regeneration.

The dehydration device shown in FIG. 1 further comprises a cooling module 9.

The cooling module 9 is a device which allows cooling the zeolite (or another adsorbent material the water adsorption thereof is exothermic) at an optimum temperature after regeneration thereof (which might have brought it to a very high temperature, for example up to about 280° C. for a zeolite).

Heat drawn during cooling could be recovered by a third heat recovery device RC3.

More particularly, in the third heat recovery device RC3, the sensible heat of the gas flow during cooling could be recovered using a (gas/gas or gas/liquid) exchanger and/or a heat pump. The use of an exchanger is preferred above a given temperature, for example in the range of 120° C. whereas the use of a heat pump is preferred below this temperature (for example between 70° C. and 120° C.).

Finally, a fourth heat recovery device RC4 may be provided for in order to recover thermal energy originating from the mechanical devices of the system, for example pumps used for the circulation of the fluids in the system. Thus, the heat recovery device RC4 may comprise one or more heat pump(s).

In FIG. 1, the heat recovery devices RC1, RC2, RC3 and RC4 are represented in a functional and general manner. Of course, numerous configurations are possible, implementing common or distinct exchangers for each drying device, or more generally for each piece of equipment of the system to which it is related.

Similarly, the recovery of thermal energy is represented in a functional and general manner, in the form of a recovery module 10, capable of ensuring the distribution or storage of the recovered thermal energy. Numerous practical implementations could be considered for this function.

Furthermore, in general, the thermal losses of a system In accordance with the present invention could be avoided by heat-insulating the constituent elements of the system: dehydration enclosure, drying device(s), lines of the systems, etc.

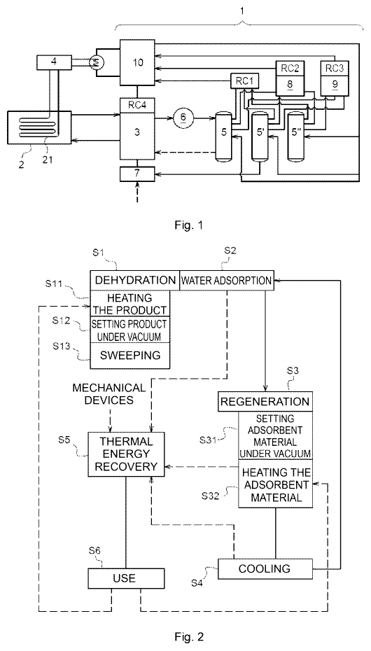

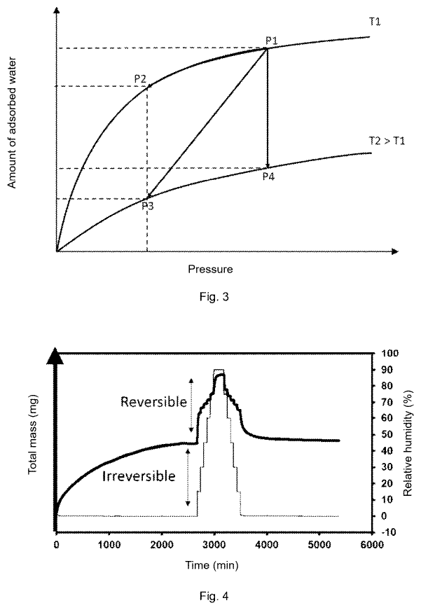

FIG. 2 schematically shows a management method that could be implemented in particular for the dehydration system of FIG. 2. The solid lines represent the sequence of the phases and steps of the method, the dotted lines the possible thermal energy flows.

A product, for example a food product, is dehydrated in a dehydration step S1. To do so, the product is set under vacuum, i.e. at a pressure at least 500 millibars lower than the atmospheric pressure. Furthermore, the product set under vacuum and heated to a temperature in the range of 30° C. to 70° C. A flow of carrier fluid (for example air or nitrogen) at low pressure and low partial pressure of water vapor is established around the product and thus “sweeps” the product to be dehydrated. Hence, the dehydration step S1 comprises steps of: heating the product S11, setting the product under vacuum S12 and sweeping S13, which are at least partially simultaneous).

At the same time as the dehydration step S1, a phase of water adsorption S2 by an adsorbent material is conducted. During this phase, water present in the carrier fluid after it has swept the product to be dehydrated is adsorbed by an adsorbent material such as a zeolite.

Preferably, the adsorption is carried out at a pressure higher than the (“vacuum”) pressure used for the dehydration step S1. Thus, the adsorption is carried out at a pressure as close as possible to the atmospheric pressure.

When the adsorbent material has adsorbed a given amount of water, it is necessary to regenerate it so as it recovers its adsorption properties. This regeneration may be carried out under vacuum. It requires a supply of thermal energy in order to heat the adsorbent material to a temperature suited to the regeneration.

Thus, the regeneration step S3 comprises, simultaneously, a step of setting the adsorbent material S31 under vacuum and a step of heating the adsorbent material S32.

In order to illustrate the phenomena implemented for the regeneration of the adsorbent material, FIG. 3 schematically shows the sorption curves as a function of the pressure for a typical adsorbent material (this type of schematic curve is observed in particular for zeolites), at two temperature levels T1 and T2, with T2>T1.

During the regeneration of the adsorbent material, the reduction of the pressure causes a release of the water adsorbed by the adsorbent, which corresponds, at a constant temperature T1, to the passage from the point P1 to the point P2 in the diagram of FIG. 3. Thus, the vacuum promotes desorption and this reduces the energy supply necessary during the regeneration phase.

Moreover, heating the adsorbent material, at constant pressure, also causes a release of the adsorbed water. This corresponds to passage from the point P1 to point P4 in the diagram of FIG. 3.

To reach higher regeneration levels, it is proposed in the context of the present invention to combine a pressure reduction with a temperature increase, which corresponds to a passage from the point P1 to the point P3 in the diagram of FIG. 3.

The temperature increase is then totally or partially carried out using the energy recovered during the adsorption phase.

The thermal energy may be supplied to the adsorbent material using a heat-transfer fluid heated in particular during the phase of adsorbing water by the adsorbent material, and during cooling of the adsorbent material after regeneration thereof, as explained hereinafter.

It is notable that, when the dehydration system comprises several drying devices comprising an adsorbent material (which forms the preferred configuration of the invention), the step of regenerating the adsorbent material may be conducted parallel to the water adsorption step, on two separate drying devices. During regeneration, hot water-laden gas is extracted from the drying device.

At the end of the regeneration S3, the adsorbent material is very hot; it may for example be at a temperature in the range of 280° C. for a zeolite. The adsorbent material is then cooled in a cooling step S4.

The cooling phase is important to obtain a use rate of the adsorbent material compatible with an industrial use. By actively cooling the adsorbent material, the availability of the drying device to carry out a drying is considerably increased.

Furthermore, the Applicant has brought to light the importance of mastering the cooling phase.

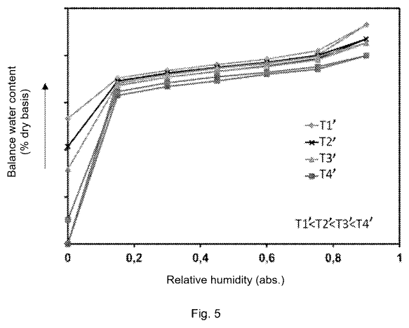

FIG. 4 shows the results obtained at a given temperature for an adsorbent (in this case a zeolite). In particular, FIG. 4 shows, as a function of time: the weight of the adsorbent (bold line), and the relative humidity of the air around and in contact with the adsorbent (thin line).

The samples used in this test have been preheated to 300° C. beforehand in order to ensure the complete desorption of the water in presence.

At the given temperature, a considerable gain in mass of the adsorbent at 0% relative humidity and between 0 and 15% relative humidity is observed in FIG. 4.

This gain is due to the adsorption of water molecules, which however are not eliminated by desorption, despite a relative humidity of the air around the adsorbent which is brought back to 0%. Thus, this phenomenon is interpreted as being an “irreversible” adsorption at the given temperature.

Nevertheless, it has been observed that the extent of this irreversibility phenomenon depends on the temperature to which the sample is subjected, as one could observe in FIG. 5.

Thus, FIG. 5 highlights two major phenomena for the efficiency of the method of the present invention. FIG. 5 shows sorption isotherms obtained at different temperatures (T1′ to T4′) for the adsorbent of FIG. 4. For a given temperature, the lower curve represents the adsorption and the upper curve the desorption. At 0% relative humidity, there is a discrepancy between the water content of the adsorbent before adsorption and after desorption, irrespective of the temperature. This discrepancy corresponds to the previously-described irreversibility phenomenon.

First of all, the maximum adsorption capacity decreases when the temperature increases. This phenomenon is deemed to be known.

Moreover, the above-mentioned irreversible nature of a portion of the adsorption is noticed at a given temperature. This phenomenon does not seem to be mentioned by the literature. One could notice that this “irreversibility” is even more significant as the temperature of the adsorbent is low.

This information is important for the method object of the invention. It demonstrates that after a regeneration phase, the adsorbent has a high capacity to re-adsorb water present in the ambient air. Such a re-adsorption represents a considerable loss of adsorption capacity for the next adsorption phase, which decreases with increasing temperature.

Thus, the application of an active cooling of the adsorbent after a regeneration allows not only carrying out an energy recovery, but also improving the overall efficiency of the system by maximizing at each cycle the amount of water adsorbed and then released for a given amount of adsorbent.

According to the invention, a thermal energy recovery step S5 is carried out. The step of recovering thermal energy S5 primarily comprises recovering heat originating from the water adsorption step S2, the adsorbent material being such that the adsorption reaction is exothermic.

This energy recovery may be carried out using a heat-transfer fluid, typically the same heat-transfer fluid as that one used to heat the adsorbent material during regeneration thereof.

The thermal energy recovery is also carried out during the step of cooling S4 the zeolite. The energy recovery during the cooling phase may be carried out using this same heat-transfer fluid, which enables a rapid heat recovery.

Complementarily, a direct exchange with a low-pressure air flow allows promoting convection despite the partial vacuum while maintaining the adsorbent material under pressure and temperature conditions where it is unlikely to re-adsorb water.

Nevertheless, the thermal energy recovery S5 may also comprise recovering heat during the regeneration: latent heat of condensation of the water present in the hot gas (gas flow) extracted from the drying device, and sensible heat of this hot gas. The recovered condensed water may also be a source of calories for the thermal energy recovery S5. Similarly, the sensible heat of the gas (typically air) coming out of the adsorbent material during cooling thereof S4 could be recovered.

Finally, the thermal energy recovery S5 may comprise recovering heat originating from the mechanical devices of the system (pumps and other machines).

The recovered thermal energy is used, in a use step S6. The use S6 may be concomitant with the thermal energy recovery S5, or be carried out later on, with a means for storing the thermal energy (for example in the form of a hot fluid stored in a heat-insulated tank).

The main uses of the recovered thermal energy cover heating the product S11 that is being dehydrated S1, and heating the adsorbent material S32 that is being regenerated S3.

The recovered thermal energy may also be used to heat a pipe-tracing fluid of the dehydration system.

FIG. 2 should be considered as a general representation of a method in accordance with an embodiment of the invention. Of course, numerous variants could be considered in the context of the present invention. In particular, the recovery of thermal energy and its use are represented respectively as unique steps. Of course, the thermal energy recovery S5 could collectively designate a plurality of distinct recoveries carried out in the context of the method for managing the dehydration system. Similarly, the use S6 of the recovered thermal energy could designate several distinct recoveries carried out in the context of the method for managing the dehydration system.

The method and the system developed in the invention allow considerably limiting the heat supplies necessary for the operation of the system. In practice, the method and the system developed in the invention allow dehydrating a product and regenerating the used drying devices by limiting the heat supplies to a low energy supply for the regeneration. The necessary heat supplies are even lower as the conditions of use of the system are optimized in terms of energy, in particular by operating at low pressure. In some embodiments of the invention, no other supply is necessary.

The Applicant presents hereinafter comparison between the estimated energy balance of a method in accordance with an embodiment of the invention and that of a comparable freeze-drying method. This balance covers the thermal energy to be supplied in the context of the dehydration of a product and does not take into consideration the energy consumption related to the operation of the mechanical systems such as the pumps used for the circulation of the various fluids in the system.

To carry out this estimation, we start with the assumption that the product to be dehydrated (1 kg product) is received at 20° C. It is also assumed that this product has the same properties as water (for example the same mass heat capacity).

The cycle implemented to dehydrate the product by freeze-drying implements the steps of: cooling the product at −40° C., dehydrating by sublimation, collecting the water by condensation, and regenerating the water collection device by defrosting.

The cycle implemented to dehydrate the product by a method in accordance with an embodiment of the invention (hereinafter referred to as “the method according to the invention”) implements the steps of: cooling the product at 4° C., dehydrating by evaporation, collecting the water by adsorption, and regenerating the adsorbent material.

For the method according to the invention, cooling down to 4° C. is intended to preserve the product between reception thereof and the dehydration. Freeze-drying requires freezing of the product and a working temperature in the range of −40° C.

Thus, the energy required to cool the product (Q_{cooling}) corresponds to:

For freeze-drying:

$${Q}_{cooling} = {Q}_{20 \to 0 ° C .} + {Q}_{freezing} + {Q}_{0 \to - 40 ° C .}$$

$${Q}_{cooling} = {mCp}_{water} Δ T + m Δ {H}_{freezing} + {mCp}_{ice} Δ T$$

$${Q}_{cooling} = 497.5 kJ$$

For the method according to the invention:

$${Q}_{cooling} = {Q}_{20 \to 4 ° C .}$$

$${Q}_{cooling} = {mCp}_{water} Δ T$$

$${Q}_{cooling} = 675 kJ$$

where ΔH denotes an enthalpy variation (or latent heat) of the element indicated in index, ΔT denotes a temperature variation, and Cₚ denotes a mass heat capacity of the element indicated in index.

The drying or dehydration step consists of a change of state of the water. This is done by sublimation in the case of freeze-drying and by evaporation in the method according to the invention. As regards the latter, the energy required to set the product at temperature, which should pass from its storage temperature (herein 4° C.) to the working temperature during drying (for example 30° C.) should also be counted.

Thus, the energy required for dehydration (Q_{drying}) is:

For freeze-drying:

$${Q}_{drying} = {Q}_{sublimation}$$

$${Q}_{drying} = m Δ {H}_{sublimation}$$

$${Q}_{drying} = 2809 kJ$$

For the metho according to the invention:

$${Q}_{drying} = {Q}_{4 \to 30 ° C .} + {Q}_{evaporation}$$

$${Q}_{drying} = {mCp}_{water} Δ T + m Δ {H}_{evaporation}$$

$${Q}_{drying} = 2366 kJ$$

The two compared methods working at very low pressures, the vapor volumes to be handled are huge. Hence, it is necessary to collect the water extracted from the product. In the case of freeze-drying, this is done most often by condensation, using a cold plate. The method according to the invention uses the adsorption principle, which is an exothermic phenomenon.

Hence, the energy required for collecting the water is:

For freeze-drying:

$${Q}_{collection} = {Q}_{condensation} + {Q}_{solidification}$$

$${Q}_{collection} = m Δ {H}_{condensation} + m Δ {H}_{solidification}$$

$${Q}_{collection} = 2591 kJ$$

For the method according to the invention:

$${Q}_{collection} = {Q}_{adsorption}$$

$${Q}_{collection} = - m Δ {H}_{adsorption}$$

$${Q}_{collection} = - 4187 kJ$$

The adsorption ratio of the zeolite is at least 12%, in the assumption detailed hereinabove it amounts to 18%. Theoretically, a zeolite under optimum and pure condition could reach an adsorption ratio of 27%. Thus, it is assumed that the zeolite is used in the method according to the invention under optimized conditions enabling an adsorption ratio in the range of 18%.

The regeneration of the water collection system requires:

For freeze-drying:

$${Q}_{regeneration} = {Q}_{fusion}$$

$${Q}_{regeneration} = m Δ {H}_{fusion}$$

$${Q}_{regeneration} = 334 kJ$$

For the method according to the invention:

$${Q}_{regeneration} = {Q}_{desorption} + {Q}_{cooling}$$

$${Q}_{regeneration} = m Δ {H}_{desorption} + {m}_{adsorbent} {Cp}_{adsorbent} Δ T$$

$${Q}_{regeneration} = 5262 kJ$$

In a method according to the invention, for desorption (regeneration), a gas flow, typically air, passes through the adsorbent material bed and serves as a carrier fluid for water vapor. Hence, at the desorption outlet, this air is hot and humid, and therefore has a high energy recovery potential for use in other steps of the method.

Similarly, the subsequent cooling of the zeolite is done by an air flow that heats up on contact with the adsorbent and from which heat could be recovered.

In an ideal theoretical case, all of the energy required for regeneration could be recovered.

The table hereinbelow summarizes the aforementioned different needs and potential gains (by recovery) in thermal energy for both methods (freeze-drying and according to the present invention).

| | | Method according | |
|---|---|---|---|
| | | to the invention | |
| Needs | Freeze-drying | (ideal case) | |
| Cooling | 497.5 kJ | 67 | kJ |
| Drying | 2809 kJ | 2366 | kJ |
| Collection | 2591 kJ | 0 | kJ |
| Regeneration Gains | 334 kJ | 5262 | kJ |
| (theoretical/ideal) | | | |
| Collection | | −4187 | kJ |
| Regeneration Balance | | −5262 | kJ |

| Total energy consumption | 6232 | −1754 |
|---|---|---|
| (kJ/kg water) | | |
| Total energy consumption | 1.73 | −0.49 |
| (kWh/kg water) | | |

The energy consumption assessed by the method described hereinabove for freeze-drying (1.73 kWh/kg of water) is in compliance with the bibliographic data, in particular those published by the Ademe (Agency of the Environment and Energy Control) and by the CETIAT (Technical Center of Aeraulic and Thermal Industries), which estimate it at 1.8 kWh/kg of water, which corroborates the calculation presented hereinabove (“Les procédés de séchage dans l'industrie”, under the coordination of Aude-Claire HOUDON et al.; ADEME Editions, February 2017, ISBN: 9791029707919).

As regards the method according to the invention, a 100% energy recovery is of course merely theoretical.

In practice, a 40% (or more) recovery of the thermal energy generated during the adsorption and a 50% (or more) recovery of the energy available in the water vapor rich gas coming out of drying device in regeneration phase have been carried out by the Applicant. These energy recovery ratios could be improved further, in particular by improving the exchangers or heat pumps used and their operating conditions.

Hence, with these recovery ratios, the method for managing a dehydration system according to the invention allows for an energy consumption of about 0.94 kWh/kg of water, which could be optimized further. This is significantly less than a freeze-drying method and this places the method proposed in the invention at the same level as the best hot air drying processes (which require between 0.9 and 1.3 kWh/kg of water), while ensuring a minimum degradation, in particular thermal degradation, of the product that is dehydrated. An energy-neutral method, or almost, except for the operation of the machines such as the pumps and the cold units, seems to be achievable by a method in accordance with the invention

Thus, a dehydration system in accordance with the present invention may require only a small supply of heat at the water trap being regenerated. Ultimately, this supply could be reduced further, and even cancelled.

All of the other heat needs could be covered by thermal energy recovery.

Finally, in order to limit the overall energy needs of the dehydration facility, excess energy under some operating conditions of the system could be used by other components of the facility (heating of sanitary water, heating of the premises, etc.).

1. A method for managing a dehydration system adapted to dehydrate a product, the dehydration system comprising a drying device containing an adsorbent material, the method comprising:
water adsorption phases (S2) by the adsorbent material to reduce the partial pressure of water vapor in a carrier fluid circulating in a dehydration system during the dehydration of the product, and
regeneration phases (S3), under vacuum, at a pressure lower by at least 500 millibars than atmospheric pressure, during which the adsorbent material recovers adsorption properties;
the adsorbent material being such that water adsorption is exothermic,
said method comprising:
recovering thermal energy (S5) at the drying device during the water adsorption phases (S2), and
using (S6) the recovered thermal energy for:
heating the product (S11) during dehydration thereof; and
heating the adsorbent material (S32) in regeneration phase,
the method further comprising, between the regeneration phase (S3) and the adsorption phase (S2), a phase (S4) of cooling the adsorbent material, and recovering thermal energy (S5) comprises recovering thermal energy at the drying device during the phase (S4) of cooling the adsorbent material.

2. The method according to claim 1, wherein recovering thermal energy (S5) comprises recovering latent heat of condensation of water vapor present in a gas flow expelled from the adsorbent material during the regeneration phases (S3).

3. The method according to claim 1, wherein recovering thermal energy (S5) comprises recovering thermal energy at a mechanical device of the dehydration system, and wherein, the recovered thermal energy is used for at least one of:
heating the product (S11) during dehydration;
heating the adsorbent material (S32) in regeneration phase; and
maintaining temperature of a heat-transfer fluid.

4. The method according to claim 1, wherein the dehydration system comprises a second drying device, wherein recovered thermal energy is used at least partially for heating the second drying device in regeneration phase.

5. The method according to claim 1, further comprising:
placing the product in a dehydration enclosure;
establishing in the dehydration enclosure a pressure at least 500 millibars lower than atmospheric pressure;
establishing a flow of carrier fluid between an inlet of the dehydration enclosure and an outlet of the dehydration enclosure; and
adsorbing water contained in a carrier fluid coming out of the dehydration enclosure by the adsorbent material contained in the drying device.

6. The method according to claim 5, wherein the pressure of the carrier fluid is raised between the outlet of the dehydration enclosure (2) and the drying device (5).

7. The method according to claim 6, wherein the pressure of the carrier fluid is raised by at least 300 millibars.

8. The method according to claim 1, wherein the product is brought and maintained at a temperature comprised between 20° C. and 70° C., during dehydration thereof.

9. The method according to claim 1, wherein heating of the adsorbent material in regeneration phase and heating of the product being dehydrated require a total amount of thermal energy and wherein a recovery of thermal energy in the system covers at least 20% of said total amount of thermal energy.

10. A dehydration system comprising
a dehydration enclosure in which a product to be dehydrated is placed, and at least one dehydration device comprising a drying device comprising an adsorbent material adapted to adsorb water contained in a carrier fluid that passes through the drying device, the adsorbent material being such that water adsorption is exothermic,
the dehydration device comprising a flow management module adapted to generate and control a flow of carrier fluid in the dehydration device and in the dehydration enclosure,
wherein the dehydration system further comprises:
a thermal energy recovery device at the drying device and at least one of
a device for distributing the thermal energy to a heater for heating the product in the dehydration enclosure (2), and
a storage device for the thermal energy for use of the thermal energy to heat the adsorbent material of the drying device when the drying device is in regeneration phase,
and wherein the system further comprises a vacuum source configured to set the adsorbent material at a pressure lower by at least 500 millibars than atmospheric pressure during regeneration thereof.

11. The system according to claim 10, wherein the device comprises a second drying device, and wherein the system further comprises means for distributing the recovered thermal energy adapted to distribute to the second drying device all or part of the recovered thermal energy in order to heat the drying material of the second drying device when it is in regeneration phase.

12. The system according to claim 10, wherein the thermal energy recovery device comprises a gas/liquid exchanger.

13. The system according to claim 10, wherein the thermal energy recovery device comprises a heat pump.

14. The system according to claim 10, further comprising means for recovering thermal energy emitted by mechanical devices of the system.

15. The system according to claim 10, wherein the dehydration enclosure (2) comprises a set of racks for receiving vessels adapted to contain a product to be dehydrated and wherein the means for heating the product comprises a set of conduits containing a heat-transfer fluid totally or partially heated via one or more exchanger(s) connected to the thermal energy recovery device.

16. The method according to claim 1, wherein the product is brought and maintained at a temperature comprised between 30° C. and 40° C., during dehydration thereof.

17. The method according to claim 1, wherein heating of the adsorbent material in regeneration phase and heating of the product being dehydrated require a total amount of thermal energy and wherein a recovery of thermal energy in the system covers at least 50% of said total amount of thermal energy.

18. The method according to claim 1, wherein heating of the adsorbent material in regeneration phase and heating of the product being dehydrated require a total amount of thermal energy and wherein a recovery of thermal energy in the system covers at least 70% of said total amount of thermal energy.

19. The method according to claim 2, wherein recovering thermal energy (S5) comprises recovering thermal energy at a mechanical device of the dehydration system, and wherein, the recovered thermal energy is used for at least one of:
heating the product (S11) during dehydration;
heating the adsorbent material (S32) in regeneration phase; and
maintaining temperature of a heat-transfer fluid.

20. The method according to claim 2, wherein the dehydration system comprises a second drying device, wherein recovered thermal energy is used at least partially for heating the second drying device in regeneration phase.
